(19) United States
(12) Patent Application Publication
(10) Pub. No.: US 2026/0178384 A1
(43) Pub. Date: Jun. 25, 2026

(54) ELECTRONIC DEVICE AND METHOD WITH TASK ALLOCATION

(71) Applicant: Samsung Electronics Co., Ltd., Suwon-si (KR)

(72) Inventors: Dong-Uk RYU, Suwon-si (KR); Ruth KIM, Suwon-si (KR); Wonik SEO, Suwon-si (KR); Sunghoon SON, Suwon-si (KR); Sungduk CHO, Suwon-si (KR)

(73) Assignee: Samsung Electronics Co., Ltd., Suwon-si (KR)

(21) Appl. No.: 19/232,268

(22) Filed: Jun. 9, 2025

(30) Foreign Application Priority Data
Dec. 19, 2024 (KR) 10-2024-0191531

(51) Int. Cl. G06F 9/48

(52) U.S. Cl. CPC G06F 9/4893

(57) ABSTRACT

An electronic device and method with task allocation are provided. The electronic device includes one or more processors configured to determine a target computing node to which a task is to be allocated among a plurality of computing nodes, based on a degradation degree of the plurality of computing nodes, and allocate the task to the target computing node, in which the plurality of computing nodes includes processing units of different types configured to execute the task.

### CROSS-REFERENCE TO RELATED APPLICATIONS

This application claims the benefit under 35 USC § 119(a) of Korean Patent Application No. 10-2024-0191531, filed on Dec. 19, 2024, in the Korean Intellectual Property Office, the entire disclosure of which is incorporated herein by reference for all purposes.

### BACKGROUND

### 1. Field

The following description relates to an electronic device and method with task allocation.

### 2. Description of Related Art

Electronic devices may include various types of semiconductor chips that degrade over time due to continued use, resulting in a limited operational lifespan. For example, the properties of elements within the semiconductor chips may change as they are subjected to prolonged exposure to heat and electric stress during their use. One manifestation of such degradation is an increase in the low supply voltage, which is a voltage to normally operate the semiconductor chips. The change of the properties of the elements may degrade the performance of the semiconductor chips and shorten their lives. To ensure long-term reliability, semiconductor chips are typically designed and manufactured by setting a design margin or a voltage margin. The voltage margin may represent a difference between an actual voltage supplied to the semiconductor chips and the low supply voltage under ideal conditions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device include one or more processors configured to determine a target computing node, among a plurality of computing nodes, to which a task is to be allocated, based on a degradation degree of the plurality of computing nodes, and allocate the task to the target computing node, wherein the plurality of computing nodes comprises processing units of different types configured to execute the task.

The one or more processors may be further configured to determine candidate computing nodes from among the plurality of computing nodes based on the degree of degradation; and determine the target computing node based on a temperature of a candidate computing node among the candidate computing nodes.

The one or more processors may be further configured to determine candidate computing nodes from among the plurality of computing nodes based on the degree of degradation; and determine the target computing node based on a cumulative use time of a candidate computing node among the candidate computing nodes.

The one or more processors may be further configured to, in response to the degradation degree being unable to be checked, determine the target computing node based on cumulative use times of candidate computing nodes.

The one or more processors may be further configured to, in response to the degradation degree being unable to be checked, determine candidate computing nodes among the plurality of computing nodes, based on a cumulative use time of the plurality of computing nodes, and determine the target computing node among the candidate computing nodes, based on temperatures of the candidate computing nodes.

The one or more processors may be further configured to, in response to the task being unable to be allocated to the target computing node, determine whether a task reservation is possible for the plurality of computing nodes, and, in response to the task reservation being impossible, determine a computing node with a least amount of use among the plurality of computing nodes as the target computing node.

The one or more processors may be further configured to, in response to the allocated task being executed by the target computing node, update either one or both of a degradation degree and a cumulative use time of the target computing node.

The one or more processors may be further configured to determine a type and number of target computing nodes based on properties of the task to be executed, and determine the target computing node among the plurality of computing nodes, based on the determined type and number of target computing nodes.

The one or more processors may be further configured to determine the type and number of target computing nodes by executing portions of the task on some of the plurality of computing nodes.

The one or more processors may be further configured to acquire the degradation degree when the plurality of computing nodes is in any one state of an idle state, a booting state, and a power-off state.

The degradation degree may be determined based on a signal delay time of a ring oscillator in a predetermined circuit of the plurality of computing nodes.

In one general aspect, a processor-implemented method includes determining a target computing node, among a plurality of computing nodes, to which a task is to be allocated, based on a degradation degree of the plurality of computing nodes; and allocating the task to the target computing node, wherein the plurality of computing nodes comprises processing units of different types capable of executing the task.

The determining of the target computing node may include determining candidate computing nodes, among the plurality of computing nodes, based on the degradation degree; and determining the target computing node based on a temperature of a candidate computing node among the candidate computing nodes.

The determining of the target computing node may include determining candidate computing nodes, among the plurality of computing nodes, based on the degradation degree; and determining the target computing node based on a cumulative use time of a candidate computing node among the candidate computing nodes.

The determining of the target computing node may include, in response to the degradation degree being unable to be checked, determining the target computing node, based on cumulative use times of candidate computing nodes.

The determining of the target computing node may include, in response to the degradation degree being unable to be checked, determining candidate computing nodes among the plurality of computing nodes, based on a cumulative use time of the plurality of computing nodes; and determining the target computing node among the candidate computing nodes, based on temperatures of the candidate computing nodes.

The determining of the target computing node may include, in response to the task being unable to be allocated to the target computing node, determining whether a task reservation is possible for the plurality of computing nodes; and, in response to the task reservation being impossible, determining a computing node with a least amount of use among the plurality of computing nodes to be the target computing node.

The method may further include, in response to the allocated task being executed by the target computing node, updating either one or both of a degradation degree and cumulative use time of the target computing node.

The determining of the target computing node may include determining a type and number of target computing nodes based on properties of the task to be executed; and determining the target computing node among the plurality of computing nodes, based on the type and number of target computing nodes.

In one general aspect, provided is a non-transitory computer-readable storage medium storing instructions that, when executed by one or more processors, configure the one or more processors to perform the method described herein.

Other features and aspects will be apparent from the following detailed description, the drawings, and the claims.

### BRIEF DESCRIPTION OF THE DRAWINGS

FIG. 1 is a diagram illustrating an example electronic device according to one or more embodiments.

FIG. 2 is a diagram illustrating an example electronic device and computing device according to one or more embodiments.

FIG. 3 is a flowchart illustrating an example method of allocating a task to computing nodes according to one or more embodiments.

FIG. 4 is a diagram illustrating an example structure of an electronic device according to one or more embodiments.

FIG. 5 is a diagram illustrating an example degradation of a computing node according to one or more embodiments.

FIG. 6 is a diagram illustrating an example low supply voltage of a computing node according to one or more embodiments.

FIG. 7 is a flowchart illustrating an example method of operating an electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component, element, or layer is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

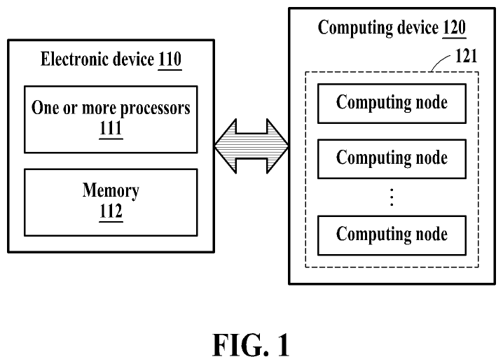

FIG. 1 is a diagram illustrating an example electronic device according to one or more embodiments.

Referring to FIG. 1, an electronic device 110 may include one or more processors 111 and a memory 112.

The electronic device 110 may be configured to allocate tasks to computing nodes 121 of a computing device 120. The electronic device may be implemented as various computing devices (e.g., a mobile phone, a smartphone, a tablet personal computer (PC), an e-book device, a laptop, a PC, a desktop, a workstation, and/or a server), various wearable devices (e.g., a smart watch, smart eyeglasses, ahead-mounted display (HMD), and/or smart clothing), various home appliances (e.g., a smart speaker, a smart television (TV), and/or a smart refrigerator), and other devices (e.g., a smart vehicle, a smart kiosk, an Internet of things (IoT) device, a walking assist device (WAD), a drone, and/or a robot), but examples are not limited to the foregoing examples.

The electronic device 110 may be provided separately from the computing device 120 and may communicate with the computing device 120 via wired or wireless communication. Although FIG. 1 illustrates the electronic device 110 as separate from the computing device 120, the computing device 120 may include the electronic device 110 according to one or more embodiments.

The one or more processors 111 may process data or perform given operations and/or tasks and may include various processors, for example, a central processing unit (CPU), a graphics processing unit (GPU), a neural processing unit (NPU), a tensor processing unit (TPU), and/or a digital signal processor (DSP). In addition, the one or more processors 111 may execute instructions or programs and may control the overall operation of the electronic device 110. The one or more processors 111 may allocate a task to be executed by the computing device 120 to one or more of the computing nodes 121. The one or more processors 111 may transmit a corresponding command to execute the allocated task to the computing device 120.

The memory 112 may store the data processed by the one or more processors 111. For example, the memory 112 may store tasks to be allocated by the one or more processors 111 or may tasks scheduled by the one or more processors 111. In addition, the memory 112 may store information such as degradation degrees, temperatures, cumulative use times, and node states of the computing nodes 121. The memory 112 may store an available node list indicating/identifying currently available computing nodes among the computing nodes 121. In addition, the memory 112 may store the instructions or programs executable by the one or more processors 111. For example, the instructions may include instructions for executing an operation of the one or more processors 111 and/or an operation of each component of the one or more processors 111. For example, the memory 112 may store a node scheduling algorithm for the one or more processors 111 to allocate tasks to the computing nodes 121.

The computing device 120 may be, as a non-limiting example, a computer, a supercomputer, and/or a high-performance computing (HPC) system. The computing device 120 may cause/configure the computing nodes 121 to execute tasks depending on the tasks allocated by the electronic device 110.

The computing nodes 121 may perform given operations and/or tasks allocated by the electronic device 110. For example, each of the computing nodes 121 may execute a task allocated by the electronic device 110 and may execute the task based on a scheduled sequence and allocated workload. The computing nodes 121 may include one or more processors for executing tasks. For example, the computing nodes 121 may include a network chip and artificial intelligence (AI) chip for implementing a network in addition to various processors, such as CPUs, GPUs, NPUs, TPUs, and DSPs. The processors of the computing nodes 121 may include semiconductor chips. The types of computing nodes 121 included in one computing device 120 may vary. For example, the computing device 120 may include computing nodes including a CPU, computing nodes including a GPU, and computing nodes including a network chip. In addition, one computing node may include multiple processors according to one or more embodiments. The computing nodes 121 may have varying performance characteristics depending on the types of tasks and operations. For example, certain tasks may be better suited to specific types of the computing nodes 121.

The computing nodes 121, or the semiconductor chips therein, may be subject to thermal and electrical stress during their use, leading degradation that affects the properties of the computing nodes 121. For example, the degradation of the computing nodes 121 may alter a voltage (e.g., a low supply voltage) for normal operation and increase power consumption caused by operations. The degradation of the computing nodes 121 may deteriorate performance, increase failure probabilities, and shorten service life. According to one or more embodiments, the electronic device 110 may determine a target computing node to execute a task among the computing nodes 121, based on degradation degrees/levels of the computing nodes 121, and may allocate the task to the target computing node. In one or more embodiments, the electronic device 110 may allocate tasks to one or more target computing nodes. In addition, the electronic device 110 may determine the target computing node based on cumulative usage time or temperatures of the computing nodes 121. By allocating tasks based on degradation degrees, the electronic device 110 may delay degradation and increase reliability of the computing device 120. In addition, by delaying the degradation of the computing nodes 121, the electronic device 110 may reduce a voltage margin at a design stage, lower a low supply voltage level during dynamic voltage frequency scaling (DVFS), and reduce power consumption.

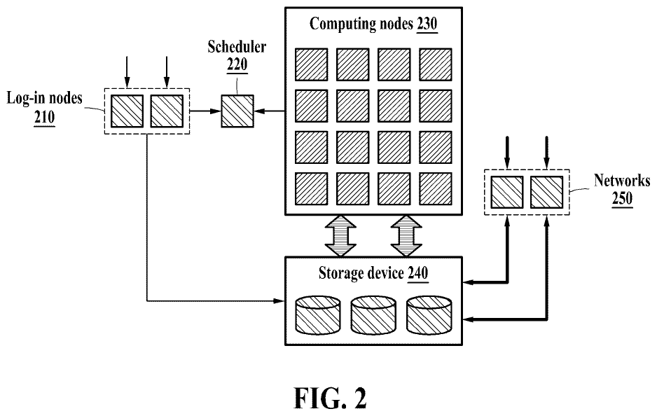

The method for task allocation by the electronic device 110 to multiple computing nodes is described in detail below with reference to FIGS. 2 through 4.

FIG. 2 is a diagram illustrating an electronic device and a computing device according to one or more embodiments.

FIG. 2 illustrates an example structure of a computing system including computing nodes 230. A scheduler 220 may manage the scheduling of tasks to be executed by the computing nodes 230. According to one or more embodiments, the electronic device may include the scheduler 220. An example connection structure shown in FIG. 2 may include log-in nodes 210, the scheduler 220, the computing nodes 230, a storage device 240, and networks 250 This structure is illustrative only and may vary according to one or more embodiments. Although FIG. 2 illustrates only two log-in nodes 210 and two networks 250, other configurations with different numbers of nodes and networks are within the scope of one or more embodiments. In addition, although only sixteen computing nodes 230 are shown, the number is not limited to this example.

Users of the computing device may request the execution of tasks through the log-in nodes 210. The log-in nodes 210 may transmit received tasks to the scheduler 220. The scheduler 220 may determine/select target computing nodes suitable for executing the tasks received from the log-in nodes 210 among the computing nodes 230 and may allocate the tasks to the target computing nodes. The target computing nodes may process the tasks allocated by the scheduler 220. In one or more embodiments, the target computing nodes may process the allocated tasks while transmitting or receiving data required for task execution using the storage device 240 and the networks 250.

The computing system may support multiple users and various application programs. Thus, the scheduler 220 may efficiently use each of the computing nodes 230 depending on the requested tasks. Because the resources of the computing nodes 230 are limited, a memory allocation amount and a core allocation setting per processor may be managed for the computing nodes under a shared node policy.

Each of the computing nodes 230 may be in a used state (e.g., allocated “alloc”) or an available state (e.g., idle) based on a resource state. In addition, each of the computing nodes 230 may include one or more processors such that a node state may be divided according to resource states of the processors.

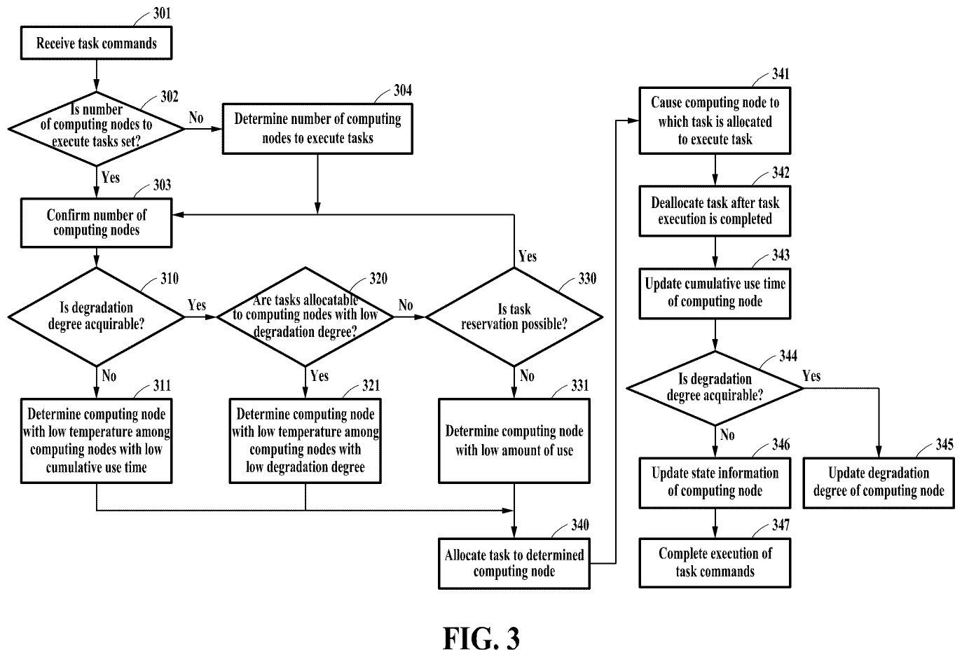

FIG. 3 is a flowchart illustrating example operations of an electronic device for allocating a task to computing nodes according to one or more embodiments.

In the one or more embodiments, operations illustrated in FIG. 3 may be performed sequentially but not necessarily. For example, the order of the operations may be changed and at least two of the operations may be performed in parallel. The operations may be performed by at least one component (e.g., a processor) of the electronic device.

In operation 301, the electronic device may receive one or more task commands to be executed across a plurality of computing nodes. For example, the electronic device may receive the task commands from a user device and/or log-in nodes.

In operation 302, the electronic device may determine whether the number of computing nodes for task execution is set in the received task commands.

In operation 303, the electronic device may confirm the number of computing nodes to execute the task commands. The electronic device may allocate tasks whether or not the number of computing nodes to execute the tasks is set in the task command.

In operation 304, if the number of computing nodes is unset or not specified, the electronic device may determine the number of computing nodes required to execute the tasks. According to one or more embodiments, the electronic device may determine the type and number of target computing nodes based on the properties of the tasks to be executed and may determine the suitable computing node(s) among the plurality of computing nodes based on their capabilities of executing the tasks.

According to one or more embodiments, the electronic device may determine/assess the type and number of target computing nodes by causing subsets of the plurality of computing nodes to execute portions of a task. For example, the electronic device may repeat partial task executions to determine the appropriate type and number of target computing nodes needed to execute a task.

In operation 310, the electronic device may determine whether a degradation degree of the plurality of computing nodes is acquirable. The degradation degree may indicate/represent the degree of the plurality of computing nodes being degraded. For example, the electronic device may determine whether degradation monitoring hardware of the plurality of computing nodes is available and usable. The electronic device may store computing nodes from which degradation degrees are acquirable and may list these computing nodes in an available node list. In response to a task being large-scale or unsuitable to be processed in the current available node list, the electronic device may allocate the task when the available node list is determined to have a node that may process the task through a task reservation.

According to one or more embodiments, the electronic device may receive or measure a respective degree of degradation from the plurality of computing nodes. The electronic device may store the respective degradation degree of the plurality of computing nodes in the available node list. The electronic device may acquire a degradation degree of a computing node if the computing node is in a stable state, such as an idle state, a booting state, or a power-off state, but examples are not limited thereto.

In one or more embodiments, a degradation degree may be determined based on a signal delay time of a ring oscillator embedded in a predetermined circuit of the plurality of computing nodes. For example, the electronic device may determine the degree of degradation by determining an operation time of a path for a specific hardware of a computing node through a ring oscillator. For example, the electronic device may determine the operation time of a path of a main circuit (e.g., a processor) of the computing node, a path using a heavily degraded element, and a path of a high-temperature location through the ring oscillator. The ring oscillator may include an odd number of NOT gates.

In operation 311, when the degree of degradation is not acquirable, the electronic device may determine a target computing node based on cumulative usage times of the plurality of computing nodes. For example, the electronic device may determine/select computing nodes with lower cumulative usage time among the plurality of computing nodes to be the target computing nodes.

According to one or more embodiments, the electronic device may determine candidate computing nodes according to a predetermined ratio among the plurality of computing nodes, based on a cumulative usage time of the plurality of computing nodes, and may determine the target computing node among the candidate computing nodes, based on temperatures of the candidate computing nodes. For example, the electronic device may determine the target computing nodes of which the number is the same as the number of target computing nodes confirmed in operation 303 among the candidate computing nodes. The candidate computing nodes may refer to the computing nodes with a low cumulative usage time among the plurality of computing nodes. The electronic device may determine computing nodes with a low temperature among the determined candidate computing nodes to be the target computing nodes.

For example, by listing the plurality of computing nodes according to their cumulative usage times and determining the candidate computing nodes in order from the lowest cumulative use time, the electronic device may list/sort the candidate computing nodes according to their temperatures and may determine the target computing nodes of which the number is the same as the number confirmed in operation 303 in order from the lowest temperature.

In operation 320, when the degradation degree is acquirable, the electronic device may determine whether tasks are allocatable to computing nodes with a low degradation degree.

In operation 321, when the tasks may be allocated to the computing nodes with a low degradation degree, the electronic device may determine a target computing node among the plurality of computing nodes, based on the degradation degree of the plurality of computing nodes. For example, the electronic device may determine the computing nodes with a low degradation degree among the plurality of computing nodes to be the target computing nodes of which the number is the same as the number confirmed in operation 303.

According to one or more embodiments, the electronic device may determine candidate computing nodes according to a predetermined ratio among the plurality of computing nodes, based on a degradation degree, and may determine the target computing node among the candidate computing nodes, based on cumulative use times of the candidate computing nodes. For example, the target computing nodes of which the number is the same as the number of target computing nodes confirmed in operation 303 may be determined among the candidate computing nodes. The candidate computing nodes may refer to the computing nodes with a low degradation degree among the plurality of computing nodes.

According to one or more embodiments, the electronic device may determine candidate computing nodes according to a predetermined ratio among the plurality of computing nodes, based on a degradation degree, and may determine the target computing node among the candidate computing nodes, based on temperatures of the candidate computing nodes and the number of target computing nodes. For example, the electronic device may determine computing nodes with a low current temperature among computing nodes with low degradation degree from the available node list to be the target computing nodes.

According to one or more embodiments, the electronic device may determine candidate computing nodes with a low degree of degradation among the plurality of computing nodes and may determine computing nodes with a low temperature among the candidate computing nodes to be the target computing nodes.

In operation 330, when the tasks are not allocatable to computing nodes with a low degradation degree, the electronic device may determine whether a task reservation is possible for the plurality of computing nodes. For example, the electronic device may determine whether the plurality of computing nodes has a task reservation function, or the task reservation function is activated. If the task reservation is possible, the electronic device may determine the target computing nodes among the plurality of computing nodes again after a predetermined time. For example, when failing to determine computing nodes with low degradation degree from the available node list, after the predetermine time according to a reservation function, the electronic device may attempt task allocation in response to a determination that computing nodes with a low temperature among the computing nodes with low degradation are from the available node list.

In operation 331, if the task reservation is impossible, the electronic device may determine a target computing node among the plurality of computing nodes again, based on the amount of use of the plurality of computing nodes. In one or more embodiments, the amount of use of the plurality of computing nodes may be determined by the amount of use of processors (e.g., a CPU or a GPU) included in each computing node.

In operation 340, the electronic device may allocate a task to the target computing node determined in operations 311, 321, and 331. The electronic device may schedule tasks to be executed by the target computing nodes based on one or more factors such as allocation amount, task sequence, and task time.

In operation 341, the electronic device may cause the target computing node to which the task is allocated to execute the task. The target computing nodes may execute the scheduled tasks.

In operation 342, when the task execution is completed in the target computing node, the electronic device may deallocate the task from the target computing node.

In operation 343, the electronic device may update the cumulative use time of the target computing node. For example, the electronic device may update the cumulative use time by summing the time spent to execute the task with the cumulative use time of the target computing node.

In operation 344, the electronic device may determine whether the degradation degree of the target computing node is acquirable.

In operation 345, when the degradation degree is acquirable, the electronic device may update the degradation degree of the plurality of computing nodes.

In operation 346, the electronic device may update the state information of the plurality of computing nodes. For example, the electronic device may update the state information of the target computing node to the available node list.

In operation 347, the electronic device may complete/finalize the execution of the task commands.

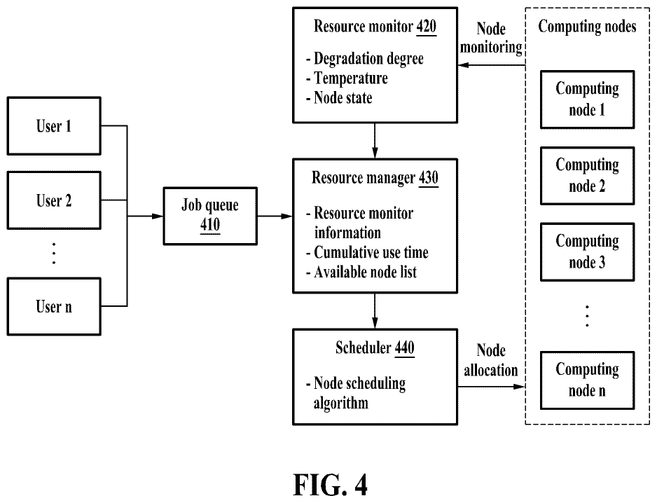

FIG. 4 is a diagram illustrating an example structure of an electronic device according to one or more embodiments.

Referring to FIG. 4, the electronic device may include a resource monitor 420, a resource manager 430, and a scheduler 440. According to one or more embodiments, the resource monitor 420, the resource manager 430, and the scheduler 440 may be implemented as separate components inside the electronic device but may also be integrated within a single component (e.g., a processor) of the electronic device.

The electronic device may store tasks requested by one or more users in a job queue 410. The resource monitor 420 may acquire/collect resource monitor information including degradation degrees, temperatures, and node states of a plurality of computing nodes. A node state may include execution time for an allocated task. The resource manager 430 may manage the resource monitor information, cumulative use times, and a list of available nodes among the plurality of computing nodes. A memory of the electronic device may store the job queue 410, the resource monitor information, the cumulative use times, and the available node list.

The scheduler 440 may allocate the tasks from the job queue 410 to target computing nodes determined/selected among the plurality of computing nodes based on the resource monitor information, the cumulative use times, and the list of available nodes among. A node scheduling algorithm may be implemented to perform the operations of the electronic device illustrated in FIG. 3.

According to one or more embodiments, the electronic device may determine the degradation degree of a computing node using degradation monitoring hardware of the computing node or data (e.g., a cumulative use time) through which a degradation tendency may be identified from a software perspective. Factors such as frequency, voltage, temperature, and use time where the computing node operates may affect the degradation degree of the computing node.

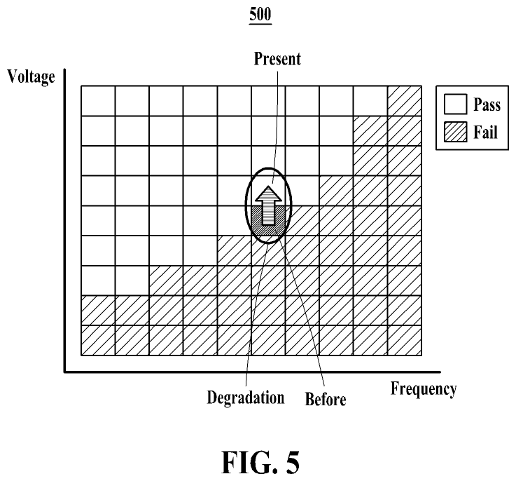

FIG. 5 is a diagram illustrating an example degradation of a computing node according to one or more embodiments.

FIG. 5 presents an example graph 500 illustrating low supply voltage behavior as the computing node undergoes degradation.

A proper supply voltage may be designed through grouping by each frequency according to the properties of a semiconductor chip. As the semiconductor chip degrades, a low supply voltage required for the semiconductor chip to operate with the same frequency may increase. For example, in graph 500, the low supply voltage to operate with the same frequency may rise from the “before” region to the “present” region. In addition, when designing the semiconductor chip to operate with the same frequency, a voltage margin may be set for the low supply voltage such that a higher voltage than the low supply voltage may be supplied to the semiconductor chip, resulting in higher power consumption. By allocating tasks based on degradation degrees across multiple computing cores, the electronic device of the one or more embodiments may slow the degradation of the computing cores, reduce power consumption required by a voltage margin, and decrease costs related to malfunctions, maintenance, and replacement.

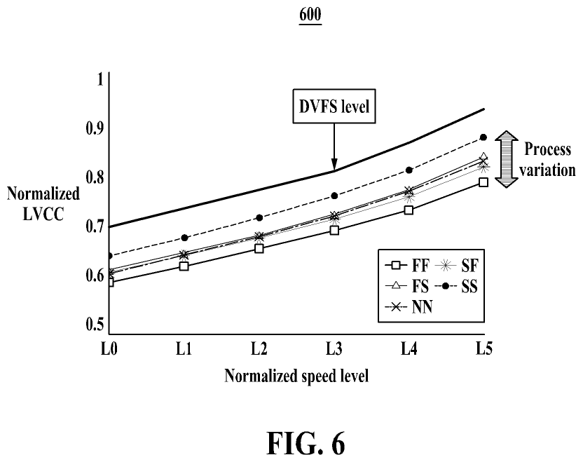

FIG. 6 is a diagram illustrating low supply voltage characteristics of a computing node according to one or more embodiments.

FIG. 6 presents an example of graph 600 showing a process variation in a dynamic voltage and frequency scaling (DVFS) level across different operation speeds of the computing node.

A semiconductor chip may require a different low supply voltage depending on an operation speed. Thus, different voltages may be supplied according to operation speeds. As illustrated in FIG. 6, the DVFS mechanism adjusts the supply voltage for each frequency such that the semiconductor chip has a different low supply voltage by each frequency through DVFS, and a voltage may be supplied according to a low supply voltage. For example, the operation speeds of the semiconductor chip may be categorized as fast/fast (FF), fast/slow (FS), slow/fast (SF), slow/slow (SS), and normal/normal (NN), each associated with distinct low voltage values.

The DVFS measures a low supply voltage by each performance for a corner case about the operation of the semiconductor chip to be applied by determining the low supply voltage by each operation speed. In addition, interspersion of semiconductor chips from changes in the processing of the semiconductor chips may be confirmed by measuring the low supply voltages. For example, to classify the properties of semiconductor chips, a delay time of a ring oscillator measured during an electrical die sort (EDS) test may be used, and the delay time may be stored in fuse-boxes within the semiconductor chips. In one or more embodiments, the electronic device may determine a degradation degree of a semiconductor chip based on a delay time of a ring oscillator with respect to a specific part of the semiconductor chip.

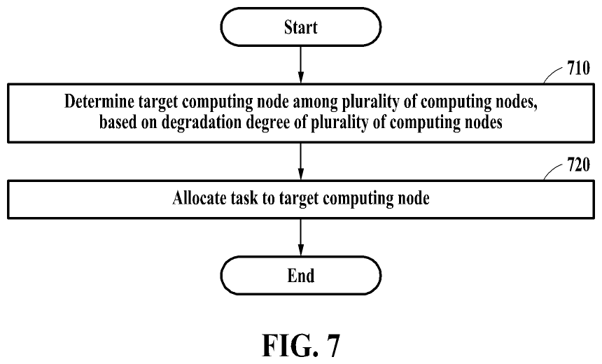

FIG. 7 is a flowchart illustrating an example method of operating an electronic device according to one or more embodiments.

In the one or more embodiments, operations may be performed sequentially or in a different order. For example, the order of the operations may be changed and at least two of the operations may be performed in parallel. Operations 710 and 720 illustrated in FIG. 7 may be performed by one or more components (e.g., a processor) of the electronic device.

In operation 710, the electronic device may determine/select a target computing node to which a task to be executed is allocated among a plurality of computing nodes, based on a degradation degree of the plurality of computing nodes. The electronic device may determine the type and number of candidate computing nodes based on the properties of the task to be executed and may determine the target computing node among the plurality of computing nodes, based on the type and number of candidate computing nodes. The electronic device may determine the type and number of candidate computing nodes by causing some computing nodes of the plurality of computing nodes to execute some/portions of a task. The electronic device may determine candidate computing nodes for executing the task, based on the degradation degree, among the plurality of computing nodes, and may determine the target computing node based on the temperature of a candidate computing node among the candidate computing nodes. The electronic device may determine candidate computing nodes for executing the task, based on the degradation degree, among the plurality of computing nodes, and may determine the target computing node based on a cumulative use time of a candidate computing node among the candidate computing nodes. The electronic device may acquire the degradation degree of the plurality of computing nodes when the plurality of computing nodes is in any one state of an idle state, a booting state, and a power-off state.

When the degradation degree of the plurality of computing nodes is unable to be checked or obtained, the electronic device may determine the target computing node among the plurality of computing nodes, based on cumulative use times of candidate computing nodes. The electronic device, when the degradation degree of the plurality of computing nodes is unable to be checked or obtained, may determine candidate computing nodes for executing the task among the plurality of computing nodes, based on a cumulative use time of the plurality of computing nodes, and may determine the target computing node among the candidate computing nodes, based on temperatures of the candidate computing nodes.

The electronic device, when the task is unable to be allocated to the target computing node, may determine whether a task reservation is possible for the plurality of computing nodes, and, when the task reservation is impossible, may determine a computing node with the least amount of use among the plurality of computing nodes to be the target computing node.

In operation 720, the electronic device may allocate a task to the target computing node.

When the allocated task is executed by the target computing node, the electronic device may update a degradation degree and/or a cumulative use time of the target computing node.

The plurality of computing nodes may include different types of processors capable of executing the task. The degradation degree may be determined based on a signal delay time of a ring oscillator for a predetermined circuit of the plurality of computing nodes.

The descriptions provided with reference to FIGS. 1 through 6 may also apply to the operations illustrated in FIG. 7, and redundant descriptions are omitted for brevity.

The electronic devices, computing devices, computing nodes, processors, memories, storage devices, electronic device 110, processors 111, memory 112, computing device 120, computing nodes 1-n/121/210/230, scheduler 220/440, storage devices 240, networks 250, resources monitor 420, source manager 430, and other apparatuses, devices, and components described herein with respect to FIGS. 1-7 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors configured to:
determine a target computing node, among a plurality of computing nodes, to which a task is to be allocated, based on a degradation degree of the plurality of computing nodes, and
allocate the task to the target computing node,
wherein the plurality of computing nodes comprises processing units of different types configured to execute the task.

2. The electronic device of claim 1, wherein
the one or more processors are further configured to:
determine candidate computing nodes from among the plurality of computing nodes based on the degree of degradation; and
determine the target computing node based on a temperature of a candidate computing node among the candidate computing nodes.

3. The electronic device of claim 1, wherein the one or more processors are further configured to:
determine candidate computing nodes from among the plurality of computing nodes based on the degree of degradation; and
determine the target computing node based on a cumulative use time of a candidate computing node among the candidate computing nodes.

4. The electronic device of claim 1, wherein the one or more processors are further configured to, in response to the degradation degree being unable to be checked, determine the target computing node based on cumulative use times of candidate computing nodes.

5. The electronic device of claim 1, wherein the one or more processors are further configured to,
in response to the degradation degree being unable to be checked, determine candidate computing nodes among the plurality of computing nodes, based on a cumulative use time of the plurality of computing nodes, and
determine the target computing node among the candidate computing nodes, based on temperatures of the candidate computing nodes.

6. The electronic device of claim 1, wherein the one or more processors are further configured to,
in response to the task being unable to be allocated to the target computing node, determine whether a task reservation is possible for the plurality of computing nodes, and,
in response to the task reservation being impossible, determine a computing node with a least amount of use among the plurality of computing nodes as the target computing node.

7. The electronic device of claim 1, wherein the one or more processors are further configured to, in response to the allocated task being executed by the target computing node, update either one or both of a degradation degree and a cumulative use time of the target computing node.

8. The electronic device of claim 1, wherein the one or more processors are further configured to:
determine a type and number of target computing nodes based on properties of the task to be executed, and
determine the target computing node among the plurality of computing nodes, based on the determined type and number of target computing nodes.

9. The electronic device of claim 8, wherein the one or more processors are further configured to determine the type and number of target computing nodes by executing portions of the task on some of the plurality of computing nodes.

10. The electronic device of claim 1, wherein the one or more processors are further configured to acquire the degradation degree when the plurality of computing nodes is in any one state of an idle state, a booting state, and a power-off state.

11. The electronic device of claim 1, wherein the degradation degree is determined based on a signal delay time of a ring oscillator in a predetermined circuit of the plurality of computing nodes.

12. A processor-implemented method, the method comprising:
determining a target computing node, among a plurality of computing nodes, to which a task is to be allocated, based on a degradation degree of the plurality of computing nodes; and
allocating the task to the target computing node,
wherein the plurality of computing nodes comprises processing units of different types capable of executing the task.

13. The method of claim 12, wherein the determining of the target computing node comprises:
determining candidate computing nodes, among the plurality of computing nodes, based on the degradation degree; and
determining the target computing node based on a temperature of a candidate computing node among the candidate computing nodes.

14. The method of claim 12, wherein the determining of the target computing node comprises:
determining candidate computing nodes, among the plurality of computing nodes, based on the degradation degree; and
determining the target computing node based on a cumulative use time of a candidate computing node among the candidate computing nodes.

15. The method of claim 12, wherein the determining of the target computing node comprises, in response to the degradation degree being unable to be checked, determining the target computing node, based on cumulative use times of candidate computing nodes.

16. The method of claim 12, wherein the determining of the target computing node comprises:
in response to the degradation degree being unable to be checked, determining candidate computing nodes among the plurality of computing nodes, based on a cumulative use time of the plurality of computing nodes; and
determining the target computing node among the candidate computing nodes, based on temperatures of the candidate computing nodes.

17. The method of claim 12, wherein the determining of the target computing node comprises:
in response to the task being unable to be allocated to the target computing node, determining whether a task reservation is possible for the plurality of computing nodes; and,
in response to the task reservation being impossible, determining a computing node with a least amount of use among the plurality of computing nodes to be the target computing node.

18. The method of claim 12, further comprising, in response to the allocated task being executed by the target computing node, updating either one or both of a degradation degree and cumulative use time of the target computing node.

19. The method of claim 12, wherein the determining of the target computing node comprises:
determining a type and number of target computing nodes based on properties of the task to be executed; and
determining the target computing node among the plurality of computing nodes, based on the type and number of target computing nodes.

20. A non-transitory computer-readable storage medium storing instructions that, when executed by one or more processors, configure the one or more processors to perform the method of claim 12.
